(19) United States
(12) Patent Application Publication
(10) Pub. No.: US 2004/0245390 A1
(43) Pub. Date: Dec. 9, 2004

(54) Emergency oxygen supply system for an aircraft

(76) Inventors: Rudiger Meckes, Berkenthin (DE); Herbert Meier, Lubeck (DE); Wolfgang Rittner, Siblin (DE)

Correspondence Address: McGLEW AND TUTTLE, P.C., Counselors at Law, SCARBOROUGH STATION, SCARBOROUGH, NY, 10510-0827, US

(21) Appl. No.: 10/850,655

(22) Filed: May 21, 2004

(30) Foreign Application Priority Data
May 22, 2003 (DE) 103 23 138.2

(51) Int. Cl. B64D 11/00

(52) U.S. Cl. 244/118.5

(57) ABSTRACT

An emergency oxygen supply system for an aircraft provides that oxygen may be made available additionally to the breathing gas supply which is brought along on board the aircraft. A gas distribution system supplies breathing masks with oxygen from one of a first oxygen source in the form of a pressurized gas source or a chemical oxygen generator. A second oxygen source is in the form of a molecular sieve bed arrangement. A change-over device selectively connects the gas distribution system to the first oxygen source or to the second oxygen source. A measurement probe delivers a status signal corresponding to a predefined flight altitude. A control unit delivers a change-over signal from the first oxygen source to the second oxygen source to the change-over device given the presence of the status signal.

### CROSS REFERENCE TO RELATED APPLICATIONS

This application claims the benefit of priority under 35 U.S.C. § 119 of DE10323138.2 filed May 22, 2003, the entire contents of which are incorporated herein by reference.

### FIELD OF THE INVENTION

The invention relates to an emergency oxygen supply system for an aircraft, and to a method for operating an emergency oxygen supply system.

### BACKGROUND OF THE INVENTION

An emergency oxygen supply system of the mentioned type is known from U.S. Pat. No. 2,934,293. A first supply line and a second supply line lead oxygen to breathing masks which are arranged along the rows of passenger seats. Here, the breathing masks are arranged in containers next to the seats. With a drop in pressure within the passenger cabin the containers are opened from a central location and the breathing masks which contain oxygen from a battery of pressurised gas bottles may be removed.

The disadvantage with the known emergency oxygen supply system is the fact that a large reservoir of oxygen must be brought along in order to also have a sufficient supply of breathing gas in extreme situations. This requires a corresponding number of pressurised gas bottles with the transport weight which results from this.

### SUMMARY OF THE INVENTION

It is the object of the present invention to improve an emergency oxygen supply system of the mentioned type in a manner such that one may provide available oxygen additionally to the breathing gas supply which is brought along. A method for operating an emergency oxygen supply system is also to be specified.

According to the invention, an emergency oxygen supply system in an aircraft is provided with a gas distribution system for supplying breathing masks with oxygen. A first oxygen source in the form of a pressurized gas source or a chemical oxygen generator is provided as well as a second oxygen source in the form of a molecular sieve bed arrangement. A change-over means is provided for selectively connecting the gas distribution system to the first oxygen source or to the second oxygen source. A measurement probe is provided for delivering a status signal corresponding to a predefined flight. A control unit delivers a change-over signal from the first oxygen source to the second oxygen source to the change-over means given the presence of the status signal.

According to another aspect of the invention, a method is provided for operating an emergency oxygen system in an aircraft. The method includes providing a gas distribution system for supplying breathing masks in the passenger space with oxygen, a first oxygen source in the form of a pressurized gas source or a chemical oxygen generator, and a second oxygen source in the form of a molecular sieve bed arrangement. Given the presence of a pressure drop in the passenger space the method connects the first oxygen source to the gas distribution system with regard to flow. The method includes switching over to the second oxygen source on reaching or falling below a predefined flight altitude.

The advantage of the invention lies essentially in the fact that additionally to the oxygen supply which is brought along, a molecular sieve bed arrangement is present which is activated below a predefined flight altitude and produces breathing gas by way of the concentration of oxygen from the turbine air. In this manner, as long as the aircraft does not exceed a predefined flight altitude of approximately 20,000 feet, one may provide oxygen for a practically unlimited time. The brought-along oxygen supply from the pressurized gas bottles in contrast is only required during an initial phase which is limited in time, until the predefined flight altitude has been reached.

Modern long haul transport aircraft today often take flight paths which often lie above uninhabited or thinly populated areas, so that a landing in the case of any disturbance is not possible, or a suitable alternative airport is distanced by several hours of flying. Aircraft in use today must drop to a flight altitude of approx. 10,000 feet in the case of disturbance in order to be able to extract breathing air from the surrounding atmosphere which is adequate for the supply of oxygen. Such a flight descent with a subsequent flight ascent demands a large consumption of fuel. With the device specified according to the invention the flight altitude only needs to be reduced to approx. 20,000 feet. Furthermore, with the molecular sieve bed arrangement the oxygen supply present in the pressurized gas bottles may be filled up again so that only a small number of pressurized gas bottles needs to be brought along.

The system and method may employ a cabin pressure sensor for delivering a cabin pressure drop signal by way of which the change-over means is actuated in a manner creating a flow connection between the first oxygen source and the gas distribution system.

The measurement probe delivering the status signal may be an altitude sensor.

The molecular sieve bed arrangement may be designed for concentrating oxygen from an air compressor.

One embodiment example of the invention is shown in the figure and is described in more detail. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a schematic view of an emergency oxygen supply system in an aircraft; and

FIG. 2 is a schematic view of a molecular sieve bed arrangement for concentrating oxygen.

### DESCRIPTION OF THE PREFERRED EMBODIMENT

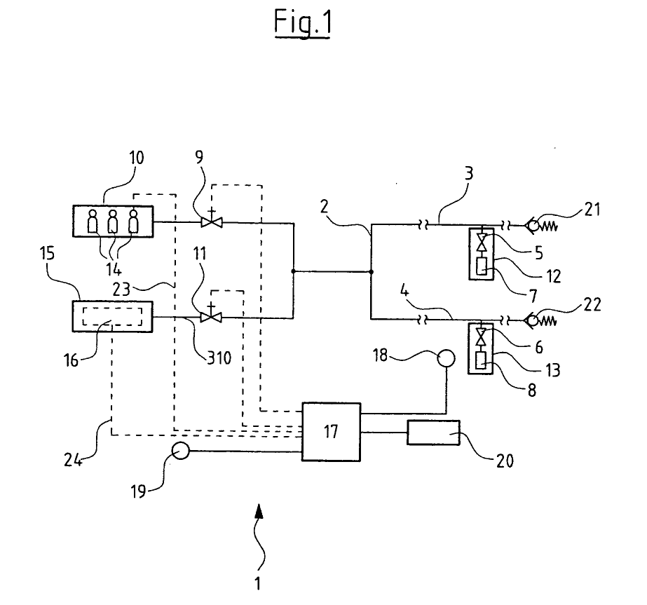

FIG. 1 schematically shows an emergency oxygen supply system 1 for an aircraft which is not shown in more detail. A gas distribution system 2 for oxygen consists of a first supply line 3 and of a second supply line 4 to which breathing masks 7, 8 are connected via throttle elements 5, 6. The supply lines 3, 4 run along rows of passenger seats not shown in FIG. 1, wherein above each row of seats a number of breathing masks 7, 8 corresponding to the seats are present in a container 12, 13 which may be opened to the bottom. The gas distribution system 2 is connected to a first oxygen source 10 via a first shut-off valve 9 and to a second oxygen source 15 via a second shut-off valve 11. The first oxygen source 10 consists of a battery of pressurized gas bottles 14 in which oxygen is kept in supply, and the second pressurized gas source 15 contains a molecular sieve bed arrangement 16 with which breathing gas is extracted by concentrating oxygen from the turbine air. A control unit 17 is connected to the shut-off valves 9, 11 of the molecular sieve bed arrangement 16, to a cabin pressure sensor 18 and to an altitude sensor 19. An operating unit 20 serves for inputting control commands and for displaying status message.

The emergency oxygen supply system 1 specified according to the invention operates as follows:

In the normal flight operation the shut-off valves 9, 11 are closed, and the cabin pressure sensor 18 delivers pressure readings to the control unit 17. The altitude sensor 19 delivers readings on the current flight altitude to the control unit 17. Pressure sensors not shown in more detail in FIG. 1 which are arranged within the first oxygen supply 10 deliver readings on the bottle pressure via the signal lead 23 so that the current oxygen supply may be determined in the control unit 17. The cabin pressure, the flight altitude as well as the oxygen supply are displayed to the pilot via the operation unit 20.

If the cabin pressure sensor 18 registers a pressure drop within the passenger space, the first shut-off valve 9 is opened and with a short burst of pressure the containers 12, 13 are opened so that the breathing masks 7, 8 fall downwards. At the same time the supply lines 3, 4 are rinsed with oxygen, wherein the rinsing gas may flow away through the pressure relief valves 21, 22. Oxygen reaches the breathing masks 7, 8 via the throttle valves 5, 6. The molecular sieve bed arrangement 16 is brought into operational readiness and warmed via the signal lead 24, which lasts about five minutes. The pilot simultaneously reduces the flight altitude to a value below 25,000 feet since sufficient oxygen is available to the molecular sieve bed arrangement 16 only at a flight altitude of approx. 20,000 feet, which may be used as a breathing gas by way of concentration. If the altitude sensor 19 registers a cabin height below 20,000 feet, the first shut-off valve 9 is closed and the second shut-off valve 11 is opened by the control unit 17. The gas supply for the breathing masks 7, 8 now comes exclusively from the second oxygen source 15.

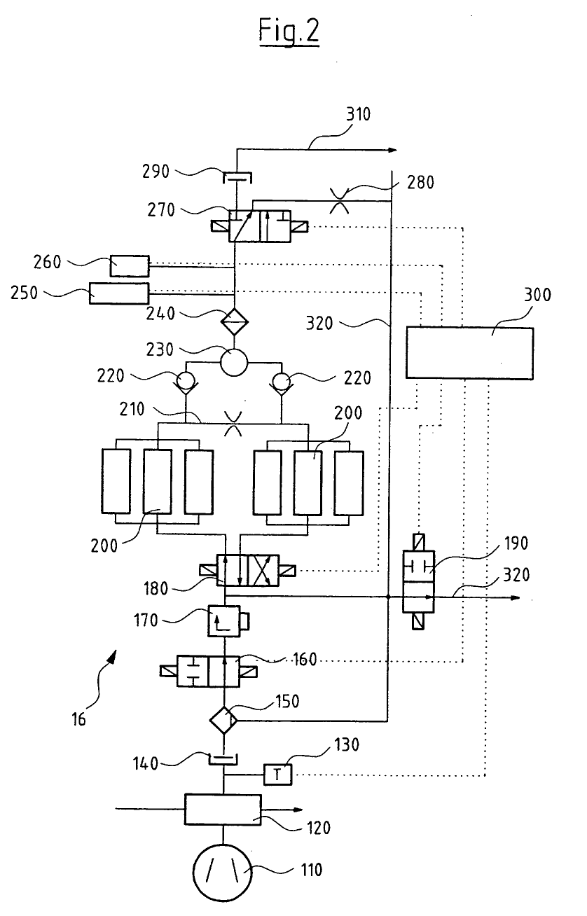

FIG. 2 shows the molecular sieve arrangement 16 with which in series sequence there are provided a turbine 110 as a high-pressure source for delivering hot turbine air, a heat exchanger 120, a temperature sensor 130, a quick closure coupling 140, a water separator 150 for removing the free water from the turbine air, a shut-off valve 160 for the feed air, a pressure reducer 170, a change-over valve 180 for the alternate filling and emptying of molecular sieve beds 200, a shut-off valve 190 for an outlet channel 320, parallel arranged molecular sieve beds 200, a flow transfer means 210, return valves 220, a product gas collection container 230, a product gas filter 240, a throughput sensor 250, an oxygen sensor 260, a change-over valve 270 for the product gas, a throttle location 280, a quick closure coupling 290, a consumer conduit 310 and a measurement and control unit 300. The consumer conduit 310 is connected to the shut-off valve 11, FIG. 1.

The molecular sieve bed arrangement 16 functions in the following manner:

The hot turbine air which is entrained with water vapor, which leaves the turbine 110 is cooled in the heat exchanger 120 to about 30 degrees Celsius. The temperature sensor 130 measures the temperature of the turbine air behind (downstream of) the heat exchanger 120 and transmits this value for further processing to the measurement and control unit 200. A water separator 150 is arranged behind the quick closure coupling 140, in which the condensation product is removed and is led away via the outlet channel 320. The shut-off valves 160 and 190 are only opened on operation of the device, they are closed for the remaining time in order to prevent a penetration of moisture into the molecular sieve beds 200. With the help of the quick closure couplings 140, 290 the device may also be completely separated from the turbine 110 and the consumer conduit 310.

The pressure reducer 170 reduces the pressure to an operating pressure of about 2 to 3 bar. Via the change-over valve 180 air is supplied to the left molecular sieve beds 200 where nitrogen is adsorbed. The right molecular sieve beds 200 are located in the desorption phase and deliver the previously combined nitrogen to the surroundings. As soon as the adsorption has been completed, the change-over valve 180 is switched over and the right molecular sieve beds 200 are used for the adsorption operation.

The product gas enriched with oxygen gets into the product gas collection container 230 via return valves 220. In order to improve the regeneration of the molecular sieve beds 200, part of the produced product gas is led via the flow transfer means 210 to the molecular sieve beds 200 arranged on the right side, which with the switch position of the change-over valve 180 shown in the figure are located in the desorption phase. The product gas is cleaned in a product gas filter 240 behind the molecular sieve beds 200. Subsequently the throughput is measured with the throughput sensor 250 and the oxygen concentration is measured with the oxygen measurement apparatus 260 and transmitted to the measurement and control unit 300.

The change-over valve 270 is activated by the measurement and control unit 300 in a manner such that during the “readiness phase” the product gas gets into the outlet channel 320 via a throttle location 280 and flows away into the surroundings. The readiness phase is present as long as the measured oxygen concentration lies below a predefined threshold value for the oxygen concentration. For this the measured oxygen concentration is constantly compared to the predefined threshold value in the measurement and control means 300. A soon as the threshold value has been reached or exceeded and the corresponding flying altitude has been reached, the change-over valve 270 receives a change-over impulse from the measurement and control unit 300 and the product gas gets into the consumer conduit 310 as long as the shut-off valve 11, FIG. 1, is opened. For the exchange of measurement and control data, the control unit 17 of the emergency oxygen system 1, FIG. 1, and the measurement and control unit 300, FIG. 2 are connected to one another by a data lead which is not shown in more detail.

While a specific embodiment of the invention has been shown and described in detail to illustrate the application of the principles of the invention, it will be understood that the invention may be embodied otherwise without departing from such principles.

What is claimed is:

1. An emergency oxygen supply system in an aircraft, the system comprising:
a gas distribution system for supplying breathing masks with oxygen;
a first oxygen source in the form of a pressurized gas source or a chemical oxygen generator;
a second oxygen source in the form of a molecular sieve bed arrangement;
a change-over means for selectively connecting the gas distribution system to the first oxygen source or to the second oxygen source;
a measurement probe for delivering a status signal corresponding to a predefined flight altitude; and
a control unit for delivering a change-over signal, for changing from the first oxygen source to the second oxygen source, to the change-over means given the presence of the status signal.

2. A device according to claim 1, further comprising a cabin pressure sensor for delivering a cabin pressure drop signal by way of which the change-over means is actuated in a manner creating a flow connection between the first oxygen source and the gas distribution system.

3. A device according to claim 1 wherein said measurement probe delivering the status signal is an altitude sensor.

4. A device according to claim 1, wherein the molecular sieve bed arrangement includes a connection to an air compressor for concentrating oxygen from the air compressor.

5. A device according to claim 2, wherein said measurement probe delivering the status signal is an altitude sensor.

6. A device according to claim 2, wherein the molecular sieve bed arrangement includes a connection to an air compressor for concentrating oxygen from the air compressor.

7. A device according to claim 3, wherein the molecular sieve bed arrangement includes a connection to an air compressor for concentrating oxygen from the air compressor.

8. A method for operating an emergency oxygen system in an aircraft having a passenger space, the method comprising the steps of:
providing a gas distribution system for supplying breathing masks in the passenger space with oxygen, a first oxygen source in the form of a pressurized gas source or a chemical oxygen generator, and a second oxygen source in the form of a molecular sieve bed arrangement;
connecting the first oxygen source to the gas distribution system, with regard to flow, given the presence of a pressure drop in the passenger space; and
switching over to the second oxygen source on reaching or falling below a predefined flight altitude.
